(19) United States
(12) Patent Application Publication
(10) Pub. No.: US 2022/0415150 A1
(43) Pub. Date: Dec. 29, 2022

(54) WIRELESS MAT FOR FIREARMS AND VALUABLES AND METHOD OF ALERTING A USER

(71) Applicants: Connor Brooksby, Washington, UT (US); Eric Joseph Brooksby, Washington, UT (US); Sheldon Shelley, St. George, UT (US)

(72) Inventors: Connor Brooksby, Washington, UT (US); Eric Joseph Brooksby, Washington, UT (US); Sheldon Shelley, St. George, UT (US)

(21) Appl. No.: 17/809,228

(22) Filed: Jun. 27, 2022

Related U.S. Application Data
(60) Provisional application No. 63/215,855, filed on Jun. 28, 2021.

(51) Int. Cl. G08B 13/24; F41A 17/06

(52) U.S. Cl. CPC G08B 13/24; F41A 17/063

(57) ABSTRACT

A system for alerting a user to unauthorized movement of an object has a mat that is embedded with a first wireless transceiver (e.g., NFC transceiver) and a second wireless transceiver (e.g., Wi-Fi® transceiver). An object, such as a firearm, has a wireless tag (e.g., NFC tag) coupled thereto for communication with the first wireless transceiver of the mat. When the object is moved, the first wireless transceiver loses connection with the wireless tag. When communication is lost, the second wireless transceiver transmits an alert to a user that the object has been moved.

### CROSS-REFERENCE TO RELATED APPLICATIONS

This application claims the benefit of U.S. Provisional Application Ser. No. 63/215,855 filed on Jun. 28, 2021, which is incorporated herein by reference.

### TECHNICAL FIELD

The present disclosure relates to securing and tracking firearms and other valuables. More specifically, the present disclosure relates to a mat that uses wireless protocols (e.g., NFC, RFID, etc.) to inform a user when a firearm or valuables are removed or otherwise distanced from the mat.

### BACKGROUND

Gun owners and others are looking to improve gun security for their safety, as well as the safety of their families and others. Gun safes are used by many gun owners, but have several shortcomings. For example, if more than one individual has access to the safe, or gains access to the safe, the owner may be unaware of the weapon(s) being taken. Indeed, the gun or weapon may be missing for a long time before the owner physically sees it missing. As a result, the owner is unaware of the missing weapon, which leads to safety concerns. Additionally, this issue is not limited to guns and weapons. For example, an owner of valuables may not know when an item of value has been stolen until they physically see it missing. If the owner does not check their valuables often, the item may be missing for a long time, which makes recovery of the item much less feasible. Again, even if these objects are locked in a safe or other compartment, other members of a household, even those that are trusted by the owner, may have access to the safe, which creates opportunities for theft and misuse.

As a result, there is a need to alert an owner when a weapon or other item of value is removed from its place of storage, whether in a drawer, a safe, on a counter, etc. The wireless mat disclosed herein solves this problem and others.

### SUMMARY OF EXAMPLE EMBODIMENTS

In some embodiments, a mat comprises a power source (e.g., battery, power cord), a microcontroller or other nano board controller, a first wireless communication protocol for communicating with a tag on an object, and a second wireless communication protocol for communicating to a user device. The wireless communication protocols may be Near Field Communication (NFC), Bluetooth®, Wi-Fi®, RFID, and/or other wireless technologies. An item of value, such as a weapon, jewelry, etc. may have a wireless tag placed thereon or built therein, allowing the microcontroller to communicate with the wireless tag on the item of value via the first wireless communication protocol. The microcontroller is configured to transmit an alert to a user via the second wireless communication protocol when the item of value has been moved a predetermined distance from the mat.

In some embodiments, a system and method of alerting a user when an object is removed from a desired location comprises placing a mat disclosed herein on a surface or securing it to a wall of a building, cabinet, etc.; securing or otherwise coupling a wireless tag to an object (e.g., firearm); and then placing the object on, or in close proximity to (generally within 4 cm), the mat. The wireless tag is then in communication with the first wireless transceiver of the mat. Based on programmed data, the mat alerts a user, via the second wireless transceiver, if the object is removed from the mat (i.e., exceeds a distance greater than 4 cm from the mat).

In some embodiments, the mat comprises a sensor for sensing when an object is on or in proximity to the mat, and a wireless communication protocol for communicating to a user when an object is moved off, or away from, the mat.

### BRIEF DESCRIPTION OF THE DRAWINGS

FIG. 1 illustrates a system for alerting a user to the removal of an object;

FIG. 2 illustrates a firearm on a mat of a system for alerting a user;

FIG. 3 illustrates a firearm being removed from the mat of a system for alerting a user;

FIG. 4 illustrates a notification received by a user's smart device when the firearm is removed from the mat of a system for alerting a user;

FIG. 5 illustrates a side perspective view of a mat of a system for alerting a user; and

FIG. 6 illustrates a system for alerting a user to the removal of an object.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.). The term “mat” is used throughout as an example. However, the present invention is not limited to a mat and may be other structures or surfaces. Additionally, the term “mat” does not require a surface that is not rigid. A mat as used herein may comprise hard materials, soft materials, or some combination.

As previously discussed, there is a need to alert an owner when a weapon or other item of value is removed from its place of storage, whether in a drawer, a safe, on a counter, etc. The wireless mat and system for alerting a user disclosed herein solves these problems and others.

Generally speaking, a mat incorporates wireless technology to communicate with a wireless chip on an item of value, such as a firearm, jewelry, etc. When the item of value is removed from the mat, as detected by the first wireless protocol and microcontroller, the microcontroller communicates to a user, via the second wireless protocol, that the item has been removed. Any number of wireless protocols may be used, such as RFID, NFC, Bluetooth®, Wi-Fi®, combinations of the foregoing, etc.

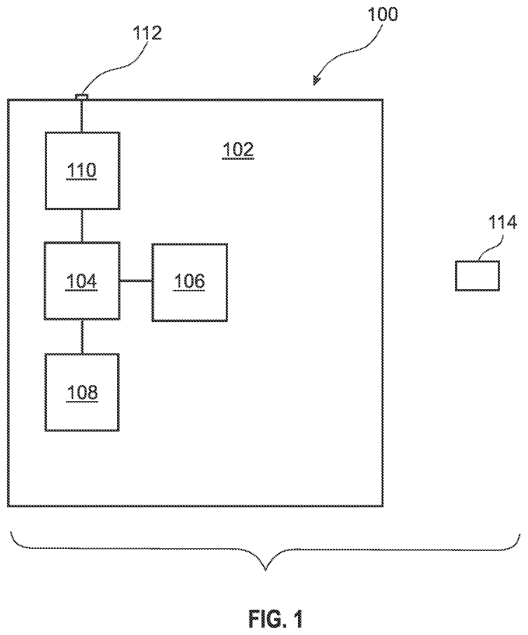

Referring now to FIG. 1, in some embodiments, a system for alerting a user 100 comprises a mat 102 comprising a microcontroller 104, a first wireless transceiver 106 (e.g., NFC transceiver), a second wireless transceiver 108 (e.g., Wi-Fi® transceiver), and a battery 110. It will be appreciated that while a battery 110 is shown, it is not required, and some embodiments comprise a plug for receiving alternating current (AC) power. Further, it will also be appreciated that the microcontroller 104, first wireless transceiver 106, and second transceiver 108 may be separate components, combined into a single component, or coupled onto a single printed circuit board (PCB). In some embodiments, the battery 110 is rechargeable via a charging connector 112 (e.g., a USB-C connector). The system for alerting a user 100 further comprises a wireless tag 114 (e.g., NFC tag) configured to be integrated with, or coupled to, an object (e.g., firearm). The wireless tag 114 is passive and therefore requires no power. For example, in aftermarket usage, a user may couple the wireless tag 114 to any desired object using adhesives or other means. For new products, a manufacturer may manufacture the object with the wireless tag 114 integrated therein so that it is non-removable. It will further be appreciated that the mat 102 may comprise a plurality of NFC transceivers 106, each for detecting a separate object, each object having a unique wireless tag 114 coupled thereto.

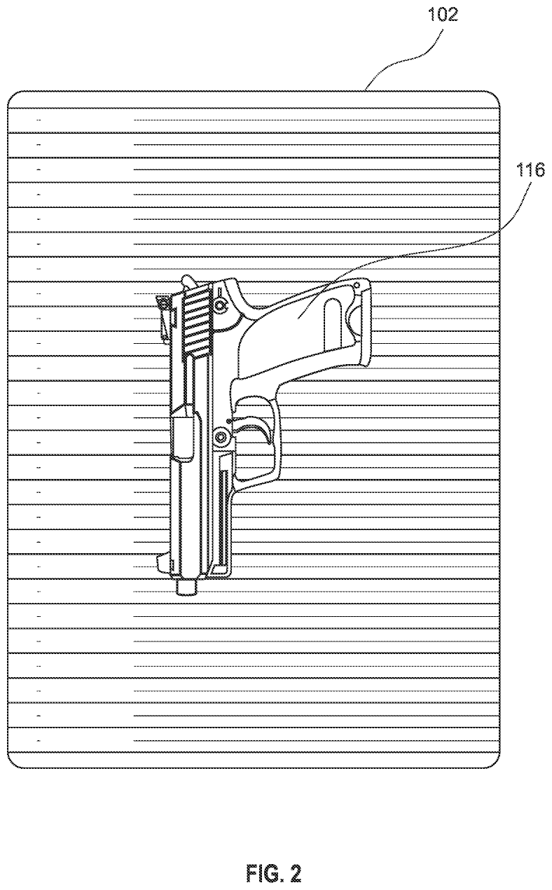

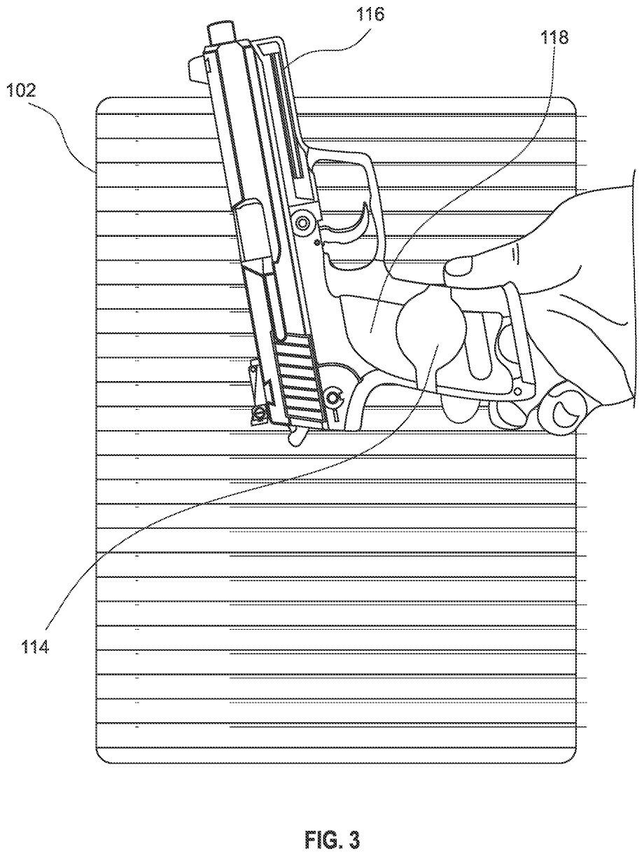

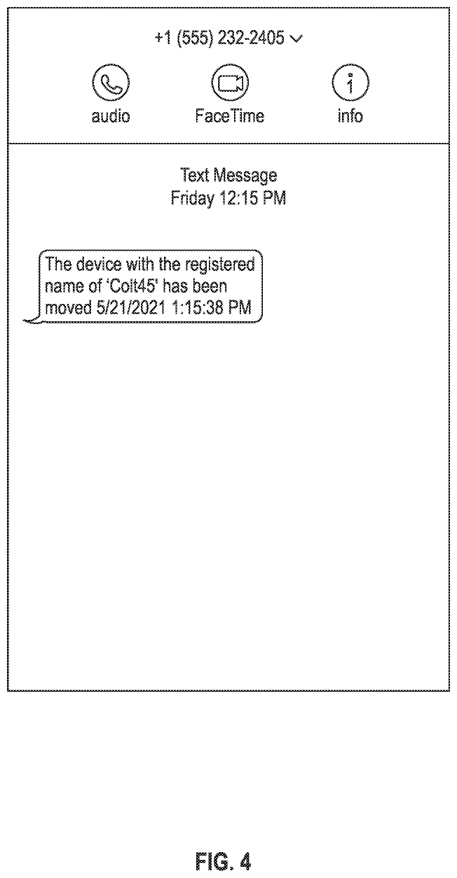

Referring to FIG. 2, a mat 102 is shown with a firearm 116 resting thereon on a first side 118 (visible in FIG. 3). As illustrated in FIG. 3, the first side 118 comprises a wireless tag 114 coupled thereto. As a result, when the first side 118 is resting on the mat 102, as illustrated in FIG. 2, the wireless tag 114 and the first wireless transceiver 106 are in wireless communication with each other using NFC or another wireless protocol. When the firearm 116 is lifted from the mat 102, as shown in FIG. 3, the first wireless transceiver 106 loses communication with the wireless tag 114. When communication is lost, the microcontroller transmits a preprogrammed alert, such as a message, to a user, as illustrated in FIG. 4. As appreciated from FIG. 4, the alert may comprise a device name and timestamp when the movement occurred. The alert may be in the form of a text message sent via cellular protocols or may be a push notification sent via the internet or other wireless protocols. It will be appreciated that a user may customize the alert and the delivery method (e.g., cellular text message, push notification to smartphone application, phone call, alarm, etc.) of the alert by inputting information to the microcontroller 104. This may be accomplished by pairing a smart device (e.g., phone, tablet, laptop, etc.) to the microcontroller 104 via the second wireless transceiver 108. A user may then input data through a user interface, such as device name (e.g., Colt 45, Diamond Necklace, etc.) and the preferred method of alert (e.g., cellular text or push notification through a smartphone application). In addition to alerts, other features may be available, such as audible alarms. The alarms may sound through speakers that are integrated into the mat, as discussed later herein, or may be separate therefrom. Additionally, the mat may be in communication with a third-party alarm system.

In addition to alarms regarding movement of an object, a user may also receive an alarm or notification regarding the battery/power status of the mat 102. In other words, if the battery is low, or an individual removes the power from the mat 102, a user would immediately be notified about the loss of power. Further, to ensure that an unauthorized user cannot simply carry the mat 102 away with the object thereon, the mat 102 may be secured to a surface using adhesives, screws, etc. In some embodiments, if the mat 102 loses a Wi-Fi® connection, the user would be alerted. For example, if an unauthorized user carried the mat 102 away from a home and the mat 102 lost connection to the Wi-Fi® signal in the home, the user would be alerted. As noted above, a user may customize the manner in which alerts are received, along with the triggering events of those alerts.

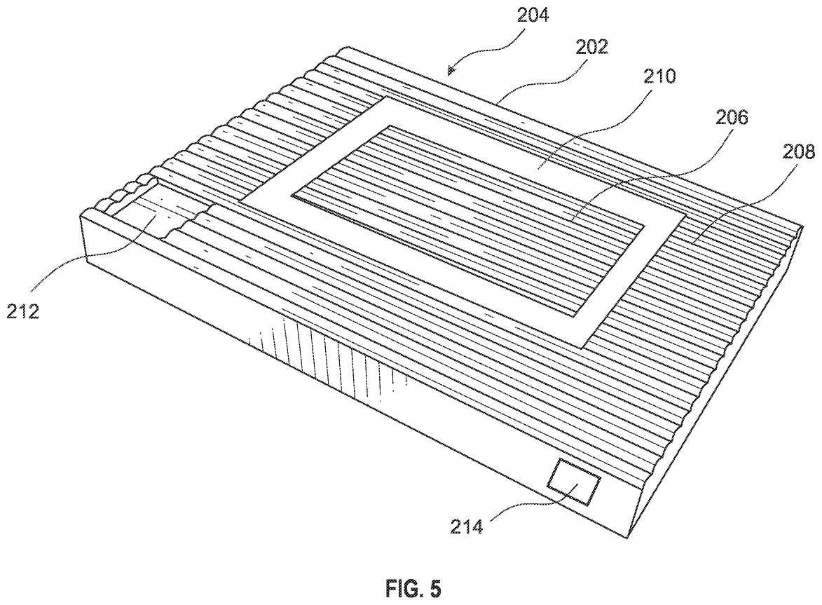

Referring to FIG. 5, a mat 202 comprises a top surface 204 comprising an active portion 206 and a passive portion 208. The active portion 206 may be surrounded by a border 210 to indicate the active portion 206. In other words, the active portion 206 comprises a first wireless transceiver 106 therein/thereunder for communicating with a wireless tag 114 of on object placed on the active portion 206. The first wireless transceiver may incorporate one or more coils to extend the antenna and range of the first wireless transceiver 106 to ensure full coverage of the active portion 206. While the active portion 206 is shown as less than the entire top surface 204, it will be appreciated that in some embodiments the entire top surface 204 may be an active portion 206.

In some embodiments, the mat 202 comprises a display panel 212. The display panel 212 may indicate battery/power status, wireless connection status for the various wireless communication protocols, alerts, logos, or other information. In some embodiments, the display panel 212 may also function as a user input device. For example, the display panel 212 may comprise a touchscreen allowing a user to input information. In one example, a user may deactivate the alerts and/or alarms by inputting a passcode into the display panel 212, thereby allowing the user to remove an object without alerts or alarms. The display panel 212 may be electrically coupled to the microcontroller 104, which may be configured to receiving the user input and activate/deactivate alerts/alarms, etc.

While the display panel 212 is shown and described, it is not required. For example, a user may pair their smartphone to the mat 202 via the second wireless transceiver and thereby program/control the controller using a smartphone application. In some embodiments, the mat 202 further comprises at least one speaker 214 for sounding an audible alarm when an item is removed without authorization. In other words, if the alarm is not deactivated via the display panel 212 or smartphone application, an alarm will sound through the speaker 214 when an object is removed from the active portion 206 of the mat 202. It will be appreciated that the alarm through the speaker 214 may be in addition to other alerts/alarms as well, such as the notification shown in FIG. 4.

In some embodiments, a method of alerting a user when an object is removed from a desired location comprises placing a mat 102, 202 on a surface or securing it to a wall of a building, cabinet, or other structure. A wireless tag 114 may then be coupled to an object (e.g., firearm 116). The object is then placed on the mat 102, 202 if on a surface, or is otherwise hung or positioned in close proximity (generally within 4 cm for NFC, although that may vary without departing herefrom) to the mat 102, 202. The wireless tag 114 is then in communication with the first wireless transceiver 106 of the mat 102, 202. Based on programmed data (such as that entered by a user via a smartphone application or via the display panel 212), the mat 102, 202 alerts a user, via the second wireless transceiver 108, if the object is removed or otherwise exceeds a distance greater than 4 cm from the mat 102, 202. While referred to as a “first” and “second” transceiver, it will be appreciated that such nomenclature is for ease of reference and that a plurality of transceivers may be used in any particular order and need not be defined as a “first” or “second” etc.

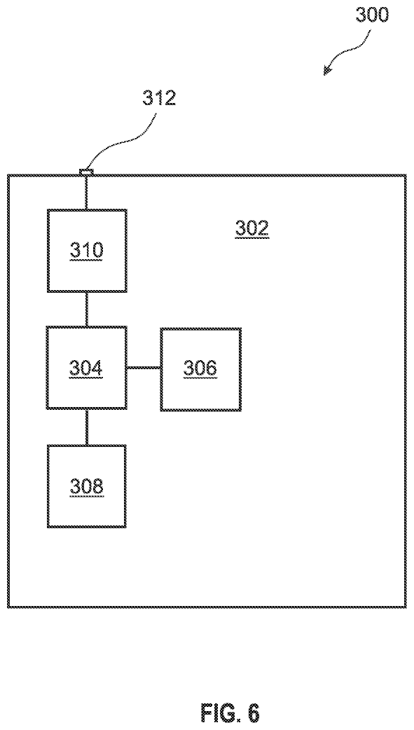

Referring to FIG. 6, in some embodiments, a system for alerting a user 300 comprises a mat 302 comprising a controller 304 (e.g., microcontroller or other processor, etc.) and a sensor 306 for sensing when an object (e.g., firearm 116) is on or in proximity to the mat 300. The sensor 306 may be an NFC transceiver, as discussed earlier herein, or may be a pressure sensor or switch or other sensor capable of detecting when an object has been removed therefrom or from its proximity. In some embodiments, the mat 302 may comprise one or more pressure sensors 306. In a mat 302 with a plurality of pressure sensors 306, the mat 302 may be divided into sections (e.g., quadrants), with a pressure sensor 306 in each section. A different object may be placed in each section so that a user may use a single mat 302 with multiple objects. While an example of a quadrant was used, it will be appreciated that such configuration is not required and that as few as one sensor and more than four may be possible. The one or more pressure sensors 306 may be programmed by a user (such as by using a phone and a wireless communication protocol) to have a specific name so that a user may know what object has been moved. For example, one sensor 306 may be named “Pistol” with a second sensor named “Necklace.” Accordingly, when an object is moved and an alert sent to a user, the user knows exactly which object has been moved from the mat 302.

It will be appreciated that when using a pressure sensor as the sensor 306, a user will first calibrate the sensor 306 by placing an object thereon and recording the pressure with the controller 304. This may be accomplished via a smartphone application that is wirelessly paired to the mat 302, such as through a wireless transceiver 308 (e.g., WiFi®, Bluetooth®). In other words, a user may pair the smartphone to the mat 302 via wireless transceiver 308. A user may then input data for logging by the controller 304, such as object name, pressure calibration, notification delivery method, and notification message, among others. In one non-limiting example, a pressure sensor 306 is in communication with a controller 304. Upon detecting a change in pressure (i.e., object removed causes pressure to decrease), the controller 304 transmits a message to a user, via the wireless transceiver 308, that the object has been moved. A user may then take swift action. This embodiment may also comprise a battery 310 and charging port 312, although not required. As appreciated from this example, a user is not required to add a tag to monitor an object, but rather simply calibrates the pressure sensor.

Accordingly, as appreciated from the foregoing, the system for alerting a user 100 solves the need to alert an owner when a weapon or other item of value is removed from its place of storage, whether in a drawer, a safe, on a counter, etc. By alerting a user, unauthorized use of an object can be quickly discovered, which, in the case of a firearm, may lead to saving lives. The system for alerting a user 100 may also deter theft in addition to unauthorized uses.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A system for alerting a user to unauthorized movement of an object, comprising:
a mat, comprising:
a power source,
a microcontroller,
a first wireless transceiver, and
a second wireless transceiver;
a wireless tag couplable to the object;
wherein the microcontroller is configured to alert the user upon determining a predetermined distance between the first wireless transceiver and the wireless tag.

2. The system of claim 1, wherein the first wireless transceiver utilizes a near field communication protocol.

3. The system of claim 1, wherein the second wireless transceiver utilizes a Wi-Fi® communication protocol.

4. The system of claim 1, wherein the power source is a battery.

5. The system of claim 4, further comprising a charging connector.

6. The system of claim 1, wherein the mat further comprises an audio speaker.

7. The system of claim 1, wherein the mat comprises an active portion and a passive portion.

8. A system for alerting a user to unauthorized movement of an object, comprising:
a mat, comprising:
a battery and a charging connector,
a microcontroller,
a first wireless transceiver utilizing near field communication protocols,
a second wireless transceiver utilizing Wi-Fi® communication protocols, and
an audio speaker;
a wireless near field communication tag couplable to the object;
a user input configured to allow a user to name the object and to determine a delivery method for an alert;
wherein the microcontroller is configured to alert the user and sound an alarm via the audio speaker upon determining a loss in communication between the first wireless transceiver and the wireless tag.

9. The system of claim 8, wherein the object is a firearm.

10. The system of claim 8, wherein the user input is a smartphone.

11. The system of claim 8, wherein the user input is a display panel on the mat.

12. A method of alerting a user to unauthorized movement of an object, the method comprising:
using a sensor in a mat to detect the presence of the object;
detecting, via the sensor, when the object has been removed; and
upon determining that the object has been removed from the mat, sending an alert, via a wireless transceiver, that the object has been removed.

13. The method of claim 12, further comprising sounding an audio alarm upon determining that the object has been removed.

14. The method of claim 12, wherein the alert comprises a cellular text message.

15. The method of claim 12, wherein the alert comprises a push notification to a smartphone application.

16. The method of claim 12, wherein the sensor is a pressure sensor.

17. The method of claim 12, wherein the sensor is a second wireless transceiver and the object comprises a wireless tag.

18. The method of claim 17, wherein a microcontroller determines that the object has been removed from the mat by determining that the wireless tag is no longer in communication with the second wireless transceiver.

19. The method of claim 18, wherein the wireless tag is passive.
